(19) United States
(12) Patent Application Publication
(10) Pub. No.: US 2020/0139310 A1
(43) Pub. Date: May 7, 2020

(54) FOAM GENERATOR FOR A VEHICLE-TREATMENT DEVICE

(71) Applicant: WashTec Holding GmbH, Augsburg (DE)

(72) Inventors: Andreas SATTLER, München (DE); Stefan MAYER, Neusäß (DE)

(21) Appl. No.: 16/627,153

(22) PCT Filed: May 28, 2018
(86) PCT No.: PCT/EP2018/063897

§ 371 Date: Dec. 27, 2019

(30) Foreign Application Priority Data
Jun. 29, 2017 (DE) 10 2017 114 582.6

(51) Int. Cl. B01F 3/04; B01F 5/06; B60S 3/04

(52) U.S. Cl. CPC B01F 3/04446; B01F 5/0696; B01F 2215/0077; B60S 3/04; B01F 5/0697

(57) ABSTRACT

A foam generator includes a foam generation chamber which contains or consists of a porous filling material and which has at least one inlet for supplying a liquid and a gas, and an outlet for discharging the foam generated in the foam generation chamber. The mean pore diameter of a cross-sectional area of the filling material decreases from the inlet to the outlet continuously or discretely.

### CROSS REFERENCE TO RELATED APPLICATIONS

This application is the United States national phase entry of International Application No. PCT/EP2018/063897, filed May 28, 2018, which claims the benefit of priority of German Application No. 10 2017 114 582.6, filed Jun. 29, 2017. The contents of International Application No. PCT/EP2018/063897 and German Application No. 10 2017 114 582.6 are incorporated by reference herein in their entireties.

### FIELD

The invention relates to a foam generator (also referred to as foam reactor), especially for a vehicle treatment device, comprising a foam generation chamber which contains a porous fill matrix, and preferably refers to a foam generator for generating washing foam. Furthermore, the invention focuses on a vehicle treatment device comprising a foam generator and a method for generating foam comprising a foam generator.

### BACKGROUND

In vehicle treatment devices at present foam generators are used, especially for generating washing foam, which as a foam generation chamber include an elongate hollow which is filled with porous material such as e.g. a knitted fiber or a particle bed, and through which a mixture of gas and liquid washing substance is flowing. The mixture components are entrained vertically from the bottom to the top onto the porous filling material for foam generation so that, while the filling material is flown through, the mixture components are mixed into a foam which leaves the foam generator at an intended outlet point.

For example, the document WO 2017/041781 A1 shows a foam generator, especially for a car wash, which includes a foam generation chamber having an inlet for water, surfactant and gas as well as an outlet for foam and which contains a bed permeable to fluids. The bed fills the foam generation chamber to such an extent that fluidization of the bed is not possible.

The document GB 2 247 411 A discloses a foam generating apparatus comprising a bead column to which a mixture of gas and foamable liquid is applied under pressure via an injector. The tortuous path matrix of the bead column produces a finely textured foam which can be applied to the target surface via an applicator head.

The document DE 34 25 078 A7 relates to a foam generator for generating foam from water, a gas and foaming agents comprising supply means for the components to the foam generator, an outlet line to supply the foam to an outlet orifice at a point of use and permeable separating elements which are arranged in the direction of flow between the inlet portion and the outlet portion of the foam generator.

In prior art, however, it is always a drawback that in foam generators for large volumes the flow volume of a foam generation chamber filled with particles, e.g. beads, cannot be increased at will, as with an axial extension of the foam generation chamber also the pressure resistance will considerably increase. Also, due to the limited construction space, the diameter of the foam generation chamber cannot be widened at will. Although filling with knitted fiber, for example felt, textile or any other tangled or randomly oriented material, allows for increasing the flow volume, an extension of the axial flow path results in segregation of the foaming components, however, i.e. disintegration of the already formed foam so that the use of knitted fiber works optimally only at a specific operating point and, resp., at a specific length of the foam generation chamber. The poor stability of the foam is especially due to the fact that the pores or channels within the filler of the foam generation chamber vary in their diameter, considering the axial length of the foam generation chamber. Pores in the filler of the foam generation chamber which become wider in the direction of flow of the foamable mixture result in segregation of the foamable mixture, which is accompanied by partial dissolution of foam bubbles and thus entails partial disintegration of the already formed foam.

### SUMMARY

Therefore, it is the object of the present invention to avoid or at least alleviate the drawbacks known from prior art and to provide a foam generator for large flow volumes which increases the stability of the foam formed.

Thus, it is a basic idea of the invention to provide a foam generation chamber the pore structure of which within the filler matrix or in the filling material is configured so that segregation of the foamable mixture is inhibited and the foamable mixture is sheared more finely in the flow path when flowing through the filling material. In other words, in the foam generation chamber of the foam generator a filling material is to be provided which generates foam having foam bubbles decreasing in the direction of flow from the foamable mixture. The filling material consists of a filler matrix and the pores or channels passing through the filling material. Filler matrix in this context is understood to be the solid body of the filling material, i.e. the part of the filling material which does not constitute but encloses and, resp., forms the hollow and, resp., the pores.

Concretely, it is suggested for the pore size and, resp., the pore diameter of a cross-sectional area of the filler material to decrease over the axial length of the foam generation chamber to reduce the bubble size of the generated foam over the length of the foam generation chamber so that, when the foam leaves the foam generation chamber, a target size of the foam bubbles is reached. The filler matrix and, resp., the filling material may be structured in stages, i.e. in several stages. The stages ideally are sequential without any spacing and the pore diameter of the stages decreases in the direction of flow of the foamable mixture. The foam generator according to the invention preferably has a diameter of 30 mm to 50 mm, especially preferred a diameter of 34 mm to 46 mm and extraordinarily preferred a diameter of 42 mm. The inner diameter of the foam generation chamber preferably amounts to 15 mm to 35 mm, especially preferred 21 mm to 29 mm and extraordinarily preferred 24 mm. The length of the foam generation chamber preferably amounts to 50 mm to 250 mm, especially preferred 120 mm to 180 mm and especially preferred 150 mm.

In total, according to the invention, advantages are achieved to the effect that the stability of the generated foam is increased by the continuously or stepwise reduced foam bubbles, while pressure resistance limiting operation in the case of rather long foam generation chambers is avoided in that the foam bubble size generated when the mixture flows through the filling material is brought to a target size not abruptly but continuously or in stages. Pressure resistance in this context is understood to be a pressure value which is dependent both on the length of the flow path of the mixture and on the pore diameter of the filling material at the inlet point of the mixture into the foam generation chamber, and which has to be applied to overcome the flow resistance of the mixture through the filling material. The smaller the diameter of the pores to be passed, the higher the pressure resistance. A continuously or gradually or, resp., stepwise increasing or jumping pore constriction also helps to build up the pressure resistance in a continuously or gradually increasing manner and will reaches its maximum value not before the position or the step at which the pore diameter is brought to a target value. The distance to be passed through the pores of minimum diameter is short as compared to prior art where no pore gradient is provided so that the pressure resistance is equally comparatively small.

Thus, the object is achieved by a foam generator, especially for a vehicle treatment device, such as a washing or polishing device, comprising a foam generation chamber which includes a porous filling material or, resp., a filler matrix enclosing pores or consists of said filler material, wherein the mean pore size or the mean pore diameter of a cross-sectional area of the filler material gradually or discretely decreases in the axial direction of the foam generation chamber over the entire axial length of the foam generation chamber from one end of the foam generation chamber (the end facing an inlet and/or an inflow portion) to the other end of the foam generation chamber (the end facing the outlet or a foam outlet opening) continuously and/or in several stages, especially in at least two stages, of preference in at least three stages and especially preferred in at least five stages (and increases at no point between the inlet and the outlet, but remains equal at least in portions, if at all).

In other words, there will be no increase in the mean pore diameter of a cross-sectional area of the filler matrix between the two ends of the foam generation chamber, while the mean pore diameter decreases in at least one portion between the two ends of the foam generation chamber. In particular, the two ends of the foam generation chamber are added to the interval boundary or, resp., the sectional areas. Hence, it is possible that between the two ends of the foam generation chamber including the two ends of the foam generation chamber the mean pore diameter decreases continuously or gradually in at least two stages or jumps. The foam generator and/or the foam generation chamber may be configured to be rigid or moderately flexible.

Advantageously, this helps to achieve stable foam bubble formation in the target size of the foam bubbles without reaching any limiting pressure resistance.

The object is also achieved by a generic foam generator whose filling material(s) is/are chosen or arranged so that from the inlet to the outlet the ratio of pressure resistance to cross-sectional area increases continuously and/or discretely, especially in two or three stages.

Of preference, the filler matrix and, resp., the filling material consists, in the axial direction of the foam generation chamber, of plural portions arranged directly in series substantially without any spacing whose cross-sectional areas differ by their mean pore diameter.

In this way, advantageously a simple structure or assembly of the filler matrix and, resp., of the filling material is achieved, as plural portions of different cross-section can be juxtaposed directly in series so as to obtain a gradient within the mean pore diameter, when viewed over the total length of the foam generation chamber. The density of the juxtaposition is especially important, as a distance between the portions corresponds to an increase in pores and results in destabilization or, resp., partial disintegration of the foam.

Especially preferred, the pores of a cross-sectional area of the filling material are substantially equal in size.

Since the stability of a foam depends on the homogeneity of the foam texture, a homogenous foaming in the form of equally sized bubbles results in increased stability of the foam as compared to a foam of inhomogeneous texture having differently sized foam bubbles. Consequently, substantially equally sized pores in a cross-sectional area result in homogeneous shearing of the foamable mixture, thus advantageously entailing a homogeneous foam bubble formation with increased stability of the foam.

In order to achieve this, especially the porosity of the filling material may decrease continuously and/or discretely, especially in two or three stages, from the inlet toward the outlet.

Porosity in this context is understood to be the ratio of the hollow volume of a body (total volume of the pores of a portion of the filling material) and the total volume of the body (volume of the total portion of the filling material, i.e. pore volume and volume of the filler matrix together) and, resp., the ratio of the passage area of a surface (total pore area in the cross-sectional area of the filling material) and the total area of the surface (total cross-sectional area of the filling material, i.e. total pore surface and filler matrix surface together):

ε_{V}=Vₚₒᵣₑₛ/Vₜₒₜₐₗ=Vₚₒᵣₑₛ/(Vₚₒᵣₑₛ+Vₘₐₜᵣᵢₓ)

ε_{A}=Aₚₒᵣₑₛ/Aₜₒₜₐₗ=Aₚₒᵣₑₛ/(Aₚₒᵣₑₛ+Aₘₐₜᵣᵢₓ)

Accordingly, the open porosity is meant for which closed pores which are not accessible to the passing fluid are left aside.

One option for increasing the flow resistance and, resp., for reducing the porosity resides in the reduction of the passage areas of the cross-sectional areas of the filling material in the axial direction of the foam generation chamber. Another option resides in maintaining the passing areas of the cross-sectional areas and increasing the number of through channels in the cross-sectional areas, with the diameter of the through channels being reduced and thus an increase in the flow resistance being brought about in the form of increased capillary forces.

Hence, a pressure loss which would result in destabilization of the foam is advantageously prevented from occurring in the foam generation chamber in the direction of flow.

Further preferred, the filling material includes particles, especially beads. It can also be stated that the filler matrix consists of particles, especially beads. In particular, the filling material in the form of a final stage at the end facing the outlet and, resp., the foam outlet opening includes a portion that consists of a particle bed. The particle bed may be held together by a net.

The spherical shape may help to advantageously obtain an as homogeneous bed as possible the porosity of which is known from literature and/or can be easily measured and/or calculated by means of the known bead diameter. Moreover, by means of the bead diameter the distance between the particles corresponding to the pore size of the bed can be controlled.

Of preference, the mean diameter of the particles decreases continuously and/or discretely, especially in two or three stages. Of advantage, this helps to obtain a gradient in the pore diameter of the cross-sectional area of the filling material in the axial direction of the foam generation chamber.

Especially preferred, the particles are made from glass. Glass is advantageous to the effect that it is an inert material and will not interact with the surrounding medium. Moreover, the smooth surface structure of the glass prevents smaller particles from the foaming mixture to attach to the surface of the beads.

Further preferred, the filling material includes a knitted fiber, especially a knitted synthetic fiber such as knitted polypropylene whose mean pore diameter or mean mesh size is decreasing continuously and/or discretely, especially in two or three stages, from the inlet toward the outlet. It is also possible that the fill matrix consists of knitted synthetic fiber such as knitted polypropylene.

Compared to beds of particles, knitted fibers offer the advantage that they are suited for large flow volumes.

Additionally preferred, a diaphragm by which the foamable mixture can advantageously be pre-mixed is arranged upstream of the filling material. The diaphragm thus may constitute a preliminary stage.

The invention further relates to a vehicle treatment device, for example to car washing plants or polishing plants comprising the afore-described foam generator according to the invention.

### BRIEF DESCRIPTION OF THE DRAWING FIGURES

Hereinafter, the invention will be illustrated by way of drawing figures, wherein:

FIG. 1 shows a longitudinal section across a first example embodiment of a foam generator according to the invention;

FIG. 2 shows a section across the filling material of a foam generator according to the invention of the first example embodiment along the cutting line II of FIG. 1;

FIG. 3 shows a section across the filling material of a foam generator according to the invention of the first example embodiment along the cutting line III of FIG. 1;

FIG. 4 shows a section across the filling material of a foam generator according to the invention of the first example embodiment along the cutting line IV of FIG. 1;

FIG. 5 shows a graphical representation of the mean pore diameter over the length of the foam generation chamber of a foam generator according to the invention of the first example embodiment;

FIG. 6 shows a longitudinal section across a second example embodiment of a foam generator according to the invention;

FIG. 7 shows a section across the filling material of a foam generator according to the invention of the second example embodiment along the cutting line VII of FIG. 6;

FIG. 8 shows a section across the filling material of a foam generator according to the invention of the second example embodiment along the cutting line VIII of FIG. 6;

FIG. 9 shows a section across the filling material of a foam generator according to the invention of the second example embodiment along the cutting line IX of FIG. 6; and

FIG. 10 shows a graphical representation of the mean pore diameter over the length of the foam generation chamber of a foam generator according to the invention of the second embodiment.

The figures are merely schematic and serve exclusively for the comprehension of the invention. Like elements are provided with like reference numerals. The features of the individual example embodiments are interchangeable.

### DETAILED DESCRIPTION

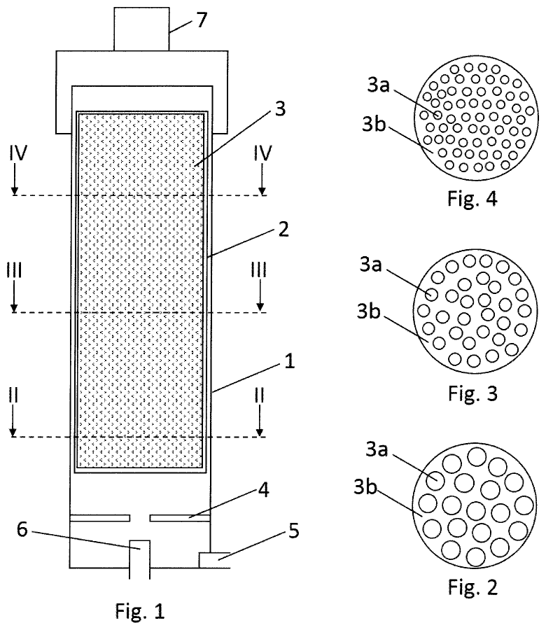

FIG. 1 illustrates a longitudinal section across a first example embodiment of a foam generator 1 according to the invention. There is evident a foam generator 1 which includes a foam generation chamber 2 of cylindrical or prism-shaped structure, for example, with a porous filling material 3. Beneath the foam generation chamber 2 a diaphragm 4 is arranged. Through an inlet 5 arranged at the lower portion of the foam generator 1 a foamable liquid component which may consist of or contains a detergent diluted with (tap) water is fed into the foam generator 1. Through an inflow portion 6 arranged at the lower portion of the foam generator 1 a gaseous component, such as, for example, air or compressed air, is introduced to the foam generator 1. The supply of a liquid component, hereinafter referred to as liquid, and a gaseous component, hereinafter referred to as gas, may be performed by applying pressure, for example by a pump. The liquid and the gas supplied to the foam generator 1 flow through the diaphragm 4 resulting in pre-mixing of the liquid and the gas, before the mixture of liquid and gas, hereinafter referred to as mixture, flows into the foam generation chamber 2. The outermost surface of the filling material 3 facing the diaphragm 4 may also be referred to as inflow point for the mixture into the foam generation chamber 2. In the upper portion of the foam generator 1 and above the foam generation chamber 2, an outlet 7 or, resp., a foam outflow opening is arranged. The outermost surface of the filling material 3 facing the outlet 7 may also be referred to as outflow point for the mixture from the foam generation chamber 2. The foam generation chamber 2 is equipped with a filling material 3 whose mean pore diameter Pₘ narrows in the direction of flow of the mixture over the axial length of the foam generation chamber 2. In said first example embodiment, the mean pore diameter Pₘ of the filling material 3 is reduced continuously, viz. at any interval between the inflow point and the outflow point. When the mixture flows through the filling material 3 and, resp., through the pores of the filling material 3, the mixture is sheared and foam bubbles are formed whose diameter is decreasing over the axial length of the foam generation chamber 2 due to the continuous pore narrowing. The mean pore diameter Pₘ of the filling material 3 is designed at the upper end of the foam generation chamber 2 such that the foam bubbles of the mixture are brought to a target diameter. At the outlet 7 of the foam generator 1 the mixture leaves the foam generator 1 in the form of a stable foam.

Each of FIGS. 2 to 4 illustrates a section across the filling material of the foam generator 1 of the first example embodiment along the cutting lines II to IV of FIG. 1. As is evident from FIGS. 2 to 4, the diameter of the pores 3a of the filling material 3 decreases from the inflow point in the direction of the outflow point. The pores 3a are surrounded by a fill matrix 3b and jointly form the filling material 3.

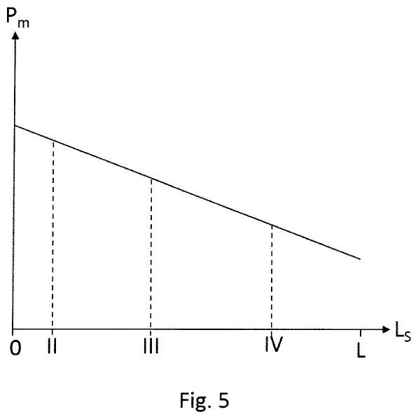

FIG. 5 illustrates a graphical representation of the mean pore diameter Pₘ over the length Lₛ of the foam generation chamber 2 of a foam generator 1 according to the invention of the first example embodiment. In this example embodiment, the mean pore diameter Pₘ continuously decreases over the axial length Lₛ of the foam generation chamber 2 from the inflow point to the outflow point. The position “0” conforms to the inflow point and the position “L” conforms to the outflow point at the foam generation chamber 2. The broken lines indicate the cross-sectional positions of the cross-sections of the filling material 3 shown in FIGS. 2 to 4 and indicated equally by broken lines in FIG. 1. The mean pore diameter Pₘ at the position “L” conforms to a target diameter by which the foam bubbles of the mixture are brought to a target size.

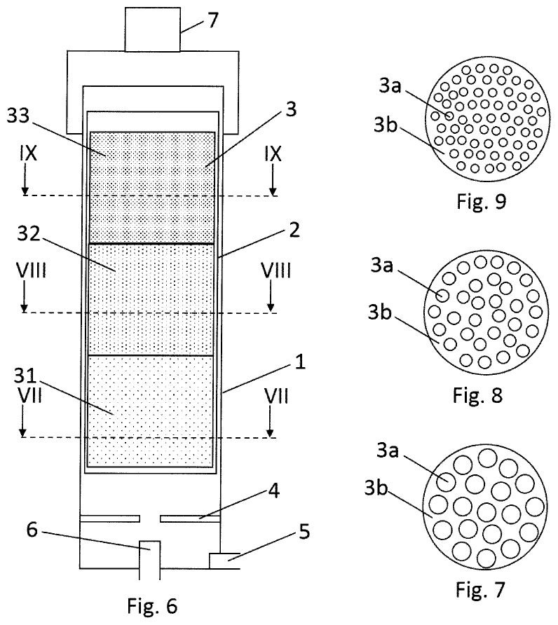

FIG. 6 illustrates a longitudinal section across a second example embodiment of a foam generator 1 according to the invention. The second example embodiment resembles the first example embodiment as to the basic structure and differs from the first example embodiment to the effect that the foam generation chamber 2 has three portions each showing a different mean pore diameter Pₘ. In said second example embodiment, the mean pore diameter Pₘ is reduced gradually, viz. in (several) stages, over the axial length Lₛ of the foam generation chamber 2 from the inflow point to the outflow point. The lower portion 31 of the filling material 3 has a large mean pore diameter Pₘ, the mean portion 32 of the filling material 3 has a medium-sized mean pore diameter Pₘ and the upper portion 33 of the filling material 3 has a small pore diameter Pₘ. A medium-sized mean pore diameter Pₘ is understood to be a mean pore diameter Pₘ which is smaller than the mean pore diameter Pₘ of the lower portion 31 and is larger than the mean pore diameter Pₘ of the upper portion 33.

Each of FIGS. 7 to 9 shows a section across the filling material 3 of the foam generation chamber 2 in the individual portions 31 to 33 of the filling material 3. It is evident here that the diameter of the pores 3a of the filling material 3 decreases from the lower portion 31 to the upper portion 33.

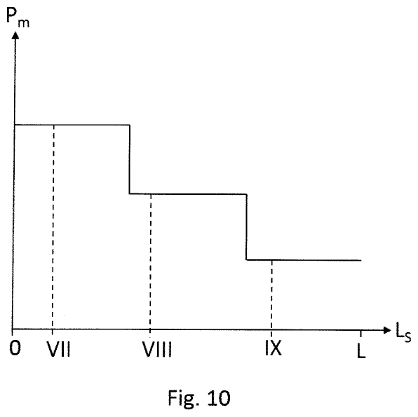

In FIG. 10, the mean pore diameter Pₘ is graphically represented over the length Lₛ of the foam generation chamber 2 of the foam generator 1 of the second example embodiment. In this example embodiment, the mean pore diameter Pₘ decreases in stages from the inflow point to the outflow point over the axial length Lₛ of the foam generation chamber 2. The position “0” conforms to the inflow point and the position “L” conforms to the outflow point at the foam generation chamber 2. The broken lines indicate the cross-sectional positions of the cross-sections of the filling material 3 shown in FIGS. 7 to 9 and indicated equally by broken lines in FIG. 6 in the portions 31 to 33. The mean pore diameter Pₘ at the position “L” conforms to a target diameter by which the foam bubbles of the mixture are brought to a target size.

1. A foam generator comprising a foam generation chamber which comprises a porous filling material and which has at least one inlet for supplying a liquid and a gas as well as an outlet for discharging the foam generated in the foam generation chamber, wherein
the mean pore diameter of a cross-sectional area of the filling material decreases from the inlet to the outlet continuously or discretely,
wherein the filling material includes knitted fibers, and
wherein the filling material consists of plural portions arranged directly in series, substantially without any spacing, the cross-sectional areas of which differ by their mean pore diameter.

2. (canceled)

3. The foam generator according to claim 1, wherein the pores of a cross-sectional area of the filling material are substantially equal.

4. The foam generator according to claim 1, wherein the porosity of the filling material decreases continuously and/or discretely from the inlet to the outlet.

5. The foam generator according to claim 1, wherein the filling material includes particles.

6. The foam generator according to claim 5, wherein the mean diameter of the particles decreases continuously and/or discretely from the inlet to the outlet.

7. The foam generator according to claim 5, wherein the particles are beads and are made from glass.

8. (canceled)

9. The foam generator according to claim 1, wherein a diaphragm is arranged upstream of the filling material.

10. A vehicle treatment device comprising a foam generator according to claim 1.
